(19) United States
(12) Patent Application Publication
(10) Pub. No.: US 2013/0174911 A1
(43) Pub. Date: Jul. 11, 2013

(54) Liquid Collection Apparatus

(71) Applicants: Timothy A. Bacich, St. Louis, MO (US); Nicholas L. Gossett, St. Charles, MO (US)

(72) Inventors: Timothy A. Bacich, St. Louis, MO (US); Nicholas L. Gossett, St. Charles, MO (US)

(21) Appl. No.: 13/344,983

(22) Filed: Jan. 6, 2012

(51) Int. Cl. B67C 11/04; B67C 11/02

(52) U.S. Cl. 137/1; 141/332

(57) ABSTRACT

A collection funnel apparatus for collecting spent cleaning fluid from a frozen dessert machine includes a collection funnel and a flexible strap attached to the collection funnel. The collection funnel includes a first side member, an opposing second side member, a first end member, an opposing second end member, and a bottom member having an arcuate shape extending from the first end member to the second end member. Also, the bottom member includes a fluid outlet. The first and second side members, the first and second end members, and the bottom member form a collection cavity.

### BACKGROUND OF THE INVENTION

The field of the invention relates generally to a collection funnel apparatus and more particularly, a collection funnel apparatus for collecting spent cleaning material from a frozen dessert machine.

Frozen dessert machines are used to make and dispense frozen deserts, for example, soft serve ice cream, frozen drinks, slushies, frozen custard, Granada, Italian ice, and frozen yogurt. Typically, a frozen dessert machine includes at least one auger positioned in a cavity of the machine. The auger is used to mix the frozen dessert, the mixed dessert is cooled and frozen before dispensing the frozen dessert from a dispensing nozzle of the frozen dessert machine. To maintain a frozen dessert machine free from bacteria and meet government sanitary requirements, the frozen dessert machine must be cleaned frequently. Typically, the frozen dessert machine is cleaned at least every two to three days. The cleaning process is time consuming and includes draining the frozen desert liquid from the machine. Water is then used to wash the bulk of the excess mix from the machine. Water is continuously run through the frozen dessert machine and collected in a bucket that is held in place by a worker. When the bucket is filled, the worker then lifts the full bucket and pours the spent cleaning fluid into a sink. Once the frozen dessert machine is clear, the machine is disassembled and all the parts of the machine that come in contact with the edible food that is consumed by customers is cleaned and sanitized. One important cleaning step is to sanitize the frozen dessert machine after the components of the frozen dessert machine have been reassembled. A sanitizing fluid is introduced into the frozen dessert machine while the frozen dessert machine is in a clean cycle to completely sanitize the components of the frozen dessert machine. The sanitizing fluid is then removed from the frozen dessert machine through the dispensing nozzles thereby also sanitizing the dispensing nozzles. The sanitizing fluid is collected in a bucket that is held in place by a worker. When the bucket is filled, the worker then lifts the full bucket and pours the spent cleaning fluid into a sink. These steps are repeated until all the cleaning/sanitizing fluid is removed from the frozen dessert machine.

Removing the cleaning fluid and sanitizing fluid from the frozen dessert machine is time consuming and is susceptible to spills and injury to the worker who must lift a full bucket of spent cleaning fluid. It would be desirable to provide a means of removing the spent cleaning fluid from the frozen dessert machine without a worker having to lift a heavy bucket and which would eliminate spills.

### BRIEF DESCRIPTION OF THE INVENTION

In one aspect, a collection funnel apparatus for collecting spent cleaning fluid from a frozen dessert machine is provided. The collection funnel apparatus includes a collection funnel and a strap attached to the collection funnel. The collection funnel includes a first side member, an opposing second side member a first end member, an opposing second end member, and a bottom member having an arcuate shape extending from the first end member to the second end member. Also, the bottom member includes a fluid outlet. The first and second side members, the first and second end members, and the bottom member form a collection cavity.

In another aspect, a method of removing spent cleaning fluid from a frozen dessert machine is provided. The method includes positioning a collection funnel apparatus on the frozen dessert machine. The collection funnel apparatus includes a collection funnel and a strap attached to the collection funnel. The collection funnel is positioned below at least one nozzle of the frozen dessert machine. The method also includes coupling a first end of a hose to a fluid outlet of the collection funnel, positioning a second end of the hose in a drain or a sink, and opening at least one nozzle of the frozen dessert machine to permit the spent cleaning fluid to flow into the collection funnel and out the fluid outlet to the drain of sink.

### BRIEF DESCRIPTION OF THE DRAWINGS

FIG. 1 is a side schematic illustration of a collection funnel apparatus in accordance of an exemplary embodiment.

FIG. 2 is a perspective schematic illustration of the collection funnel shown in FIG. 1.

FIG. 3 is an end schematic illustration of the collection funnel shown in FIG. 1.

FIG. 4 is a top schematic illustration of the strap shown in FIG. 1.

FIG. 5 is a top schematic illustration of the collection funnel shown in FIG. 1.

FIG. 6 is a perspective schematic illustration of the collection funnel apparatus shown in FIG. 1 attached to a frozen dessert machine.

### DETAILED DESCRIPTION OF THE INVENTION

A collection funnel apparatus for collecting spent cleaning and or sanitizing fluid from a frozen dessert machine is described below in detail. The collection funnel includes a collection funnel having a fluid outlet, and a strap attached to the collection funnel. The strap permits the collection funnel to be held in place below the nozzle(s) of the frozen dessert machine for collection of spent cleaning fluid. The spent cleaning fluid drains through the funnel fluid outlet and a hose connected at one end to the fluid outlet. The other end of the hose may be placed in a sink or a floor drain for removing the spent cleaning fluid from the collection funnel. The collection funnel apparatus facilitates cleaning a frozen dessert machine in less time than known cleaning techniques. In addition, the collection funnel apparatus eliminates the need for a worker from holding a bucket at a frozen dessert machine to collect spent cleaning/sanitizing fluids and then having to carry the heavy filled bucket to a sink to empty the bucket. Eliminating carrying heavy buckets of spent cleaning/sanitizing fluids prevents the spilling of spent cleaning/sanitizing fluids which may cause the worker to slip and/or fall, and reduces worker fatigue.

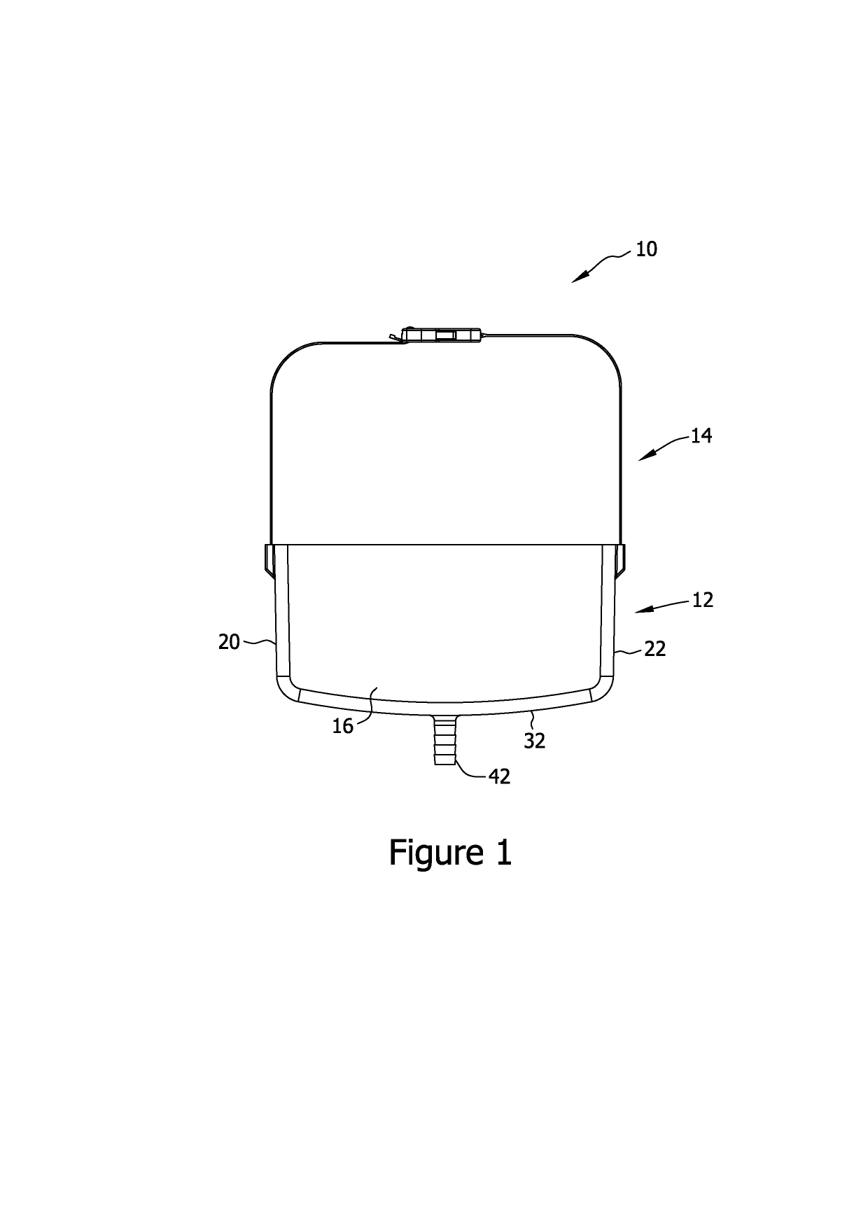

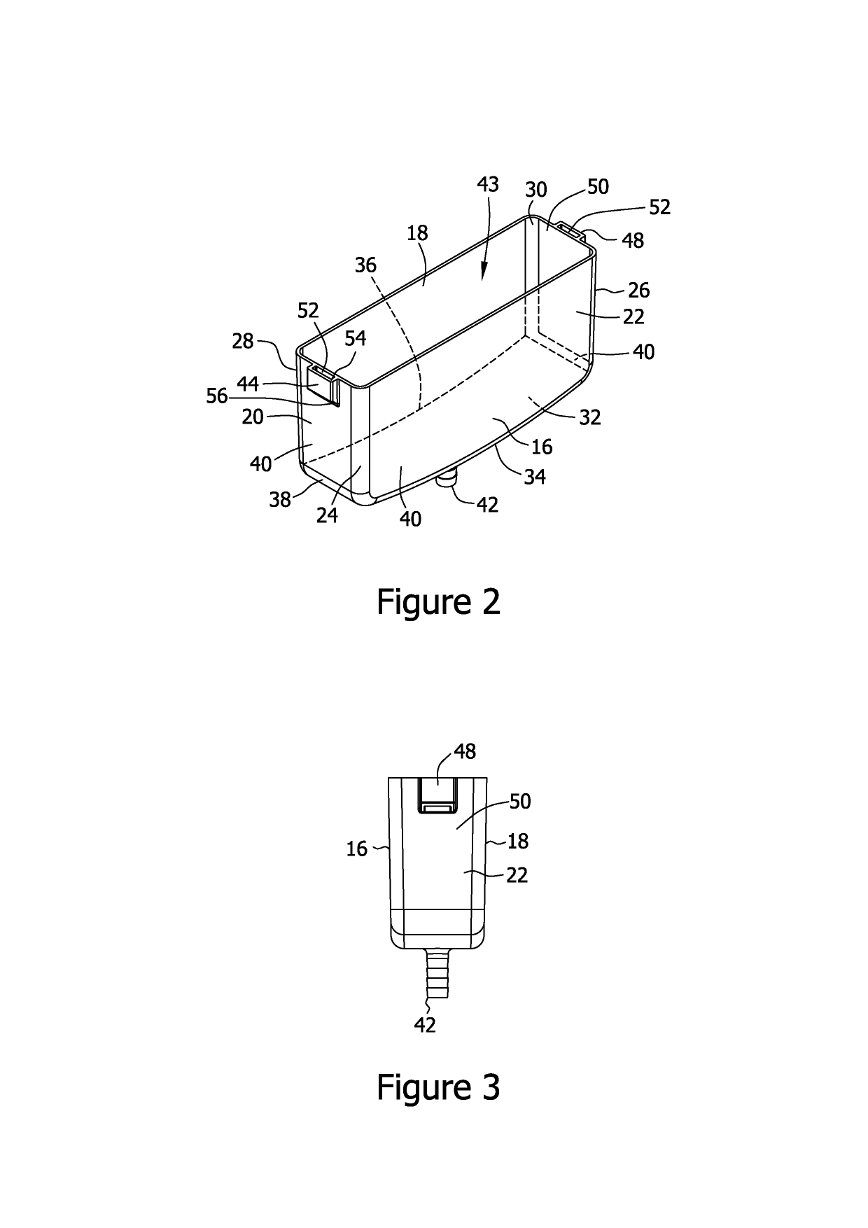

Referring to the drawings, FIG. 1 is a side schematic illustration of a collection funnel apparatus 10 in accordance of an exemplary embodiment. Collection funnel apparatus 10 includes a collection funnel 12 and a flexible strap 14 removably attached to collection funnel 12. Referring also to FIGS. 2 and 3, collection funnel 12 includes a first side panel 16 and an opposing second side panel 18, a first end panel 20 and an opposing second end panel 22. First side panel 16 is attached to first end panel 20 at a first corner 24, and to second end panel 22 at a second corner 26. Second side panel 18 is attached to first end panel 20 at a third corner 28, and to second end panel 22 at a fourth corner 30.

A bottom panel 32 is attached to first side panel 16 at a fifth corner 34, and to second side panel 18 at a sixth corner 36. Bottom panel 32 is also attached to first end panel 20 at a seventh corner 38, and to second end panel 22 at a eighth corner 40. Bottom panel 32 is arcuate in shape to permit a fluid to be directed to a fluid outlet 42 in bottom panel 32 located in the center of bottom panel 32. First and second side panels 16 and 18, first and second end members 20 and 22, and said bottom member 32 define a collection cavity 43.

First end panel 20 includes a strap connecting member 44 extending outward from an outer surface 46 of first end panel 20. Also second end panel 22 includes a strap connecting member 48 extending outward from an outer surface 50 of second end panel 22. Connecting members 46 and 48 each include a channel 52 extending from a top 54 of connecting members 46 and 48, and through the bottom 56 of connecting members 46 and 48. Channel 52 is sized to permit flexible strap 14 to extend through channel 52.

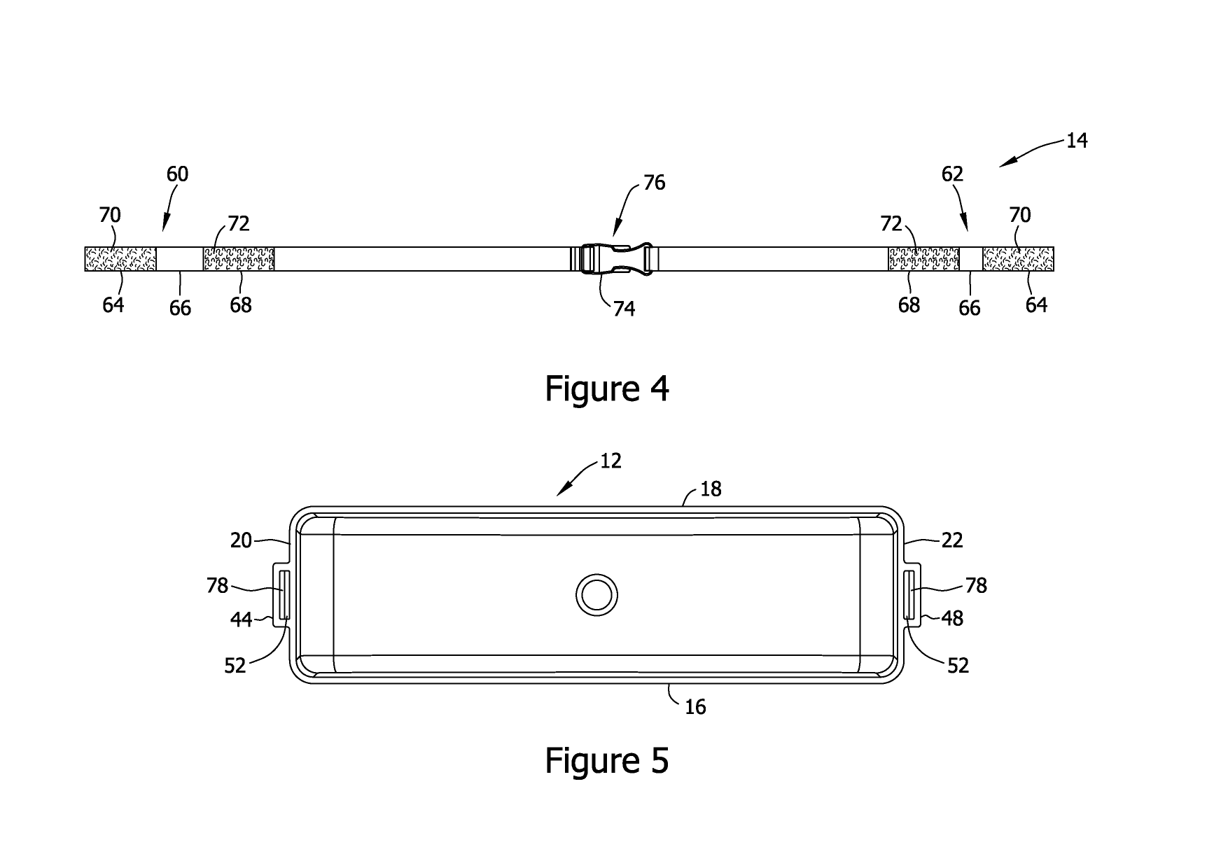

Referring also to FIG. 4, flexible strap 14 includes a first end 60 and a second end 62. First end 60 and second end 62 each include a hook and loop fastener that is used to attach strap 14 to connecting members 46 and 48. First end 60 and second end 62 each include a first portion 64, a second portion 66, and a third portion 68 with second portion 66 positioned between first portion 64 and third portion 68. A plurality of hooks 70 are attached to first portions 64, and a plurality of loops 72 are attached to third portions 68. Any hook and loop fastener may be used, for example, a Velcro® brand hook and loop fastener. A buckle 74 is attached to a center portion 76 of flexible strap 14. Buckle 74 facilitates changing the length of flexible strap 14, thereby permitting collection funnel to be positioned at a desired position on a frozen dessert machine to collect spent cleaning fluid from the frozen dessert machine. Flexible strap 14 may be, in one embodiment, a molded or extruded thermoplastic, and in another embodiment a woven web of thermoplastic fibers.

Flexible strap 14 is attached to collection funnel 12 by inserting first end 60 of flexible strap 14 through channel 52 of connecting member 46. First portion 64 is folded around connecting member 46 and connecting first portion 64 to third portion 68 by engaging hooks 70 with loops 72. Similarly, second end 62 of flexible strap 14 is inserted through channel 52 of connecting member 48. First portion 64 is folded around connecting member 48 and connecting first portion 64 to third portion 68 by engaging hooks 70 with loops 72. In another embodiment, a bar 78 extends horizontally in each channel 52 of connecting members 46 and 48 (shown in FIG. 5), and first and second ends 60, 62 are wrapped around bars 78 in channels 52.

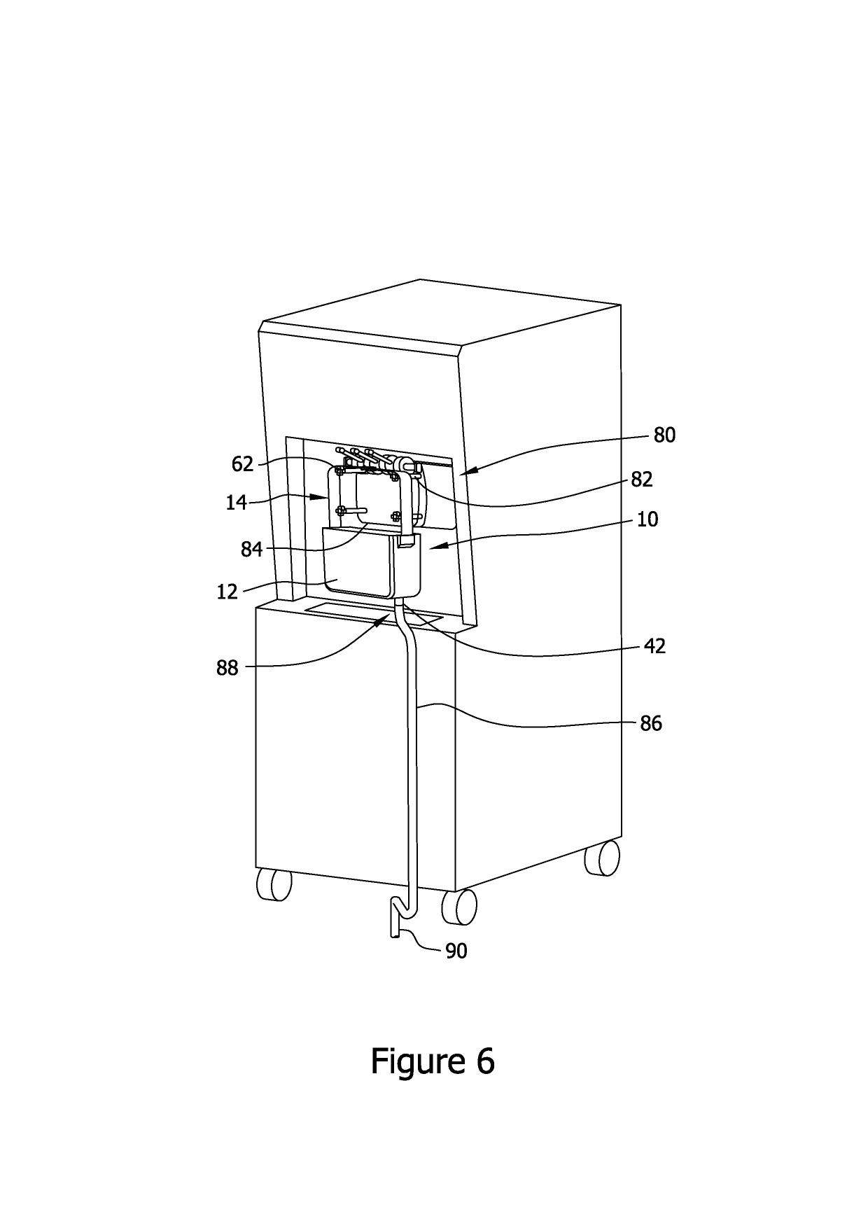

FIG. 6, is a perspective schematic illustration of collection funnel apparatus 10 attached to a frozen dessert machine 80. Flexible strap 14 is positioned on cover bolts 82 of frozen dessert machine 80 which holds collection funnel 12 in place below nozzles 84 of frozen dessert machine 80. A hose (or pipe) 86 is coupled at a first end 88 to fluid outlet 42, and second end 90 of hose 86 may be positioned in a floor drain or a sink for removing the spent cleaning fluid collection funnel 12.

Collection funnel 12 and flexible strap 14 are made from thermoplastic materials. Suitable thermoplastic materials include, but not limited to, polyethylene, polypropylene, polystyrene, acrylonitrylstyrene, butadiene, polyethyleneterephthalate, polybutyleneterephthalate, polyarylene ethers, polycarbonates, polyestercarbonates, thermoplastic polyesters, polyetherimides, acrylonitrile-butylacrylate-styrene polymers, nylon, polyarylene ether ketone, polyphenylene sulfide, polyaryl sulfone, polyether sulfone, and polyvinylchloride. Strap 14 may also include elastomer materials which may be combined to form copolymers or blends of polymers having flexible properties. For example, the elastomer materials may be composed of polyethylene co-polymers with propylene, butene, hexene, octene, ethylidene norbornene and/or other alpha-olefin co-monomers. In similar fashion, elastomeric co-polymers based on polypropylene may be used.

In addition, the thermoplastic materials may include reinforcing agents and/or fillers. Suitable reinforcing agents may include, but not limited to, glass fibers, graphite fibers, carbon fibers, ceramic fibers, metal fibers, metalized inorganic fibers, metalized synthetic fibers, aramid fibers, and the like. Suitable fillers may include, but not limited to, talc, mica, glass particles, silica, wollastonite, and the like. The thermoplastic materials may also include color concentrates. Suitable color concentrates may include, but not limited to, color pigments and or dyes dispersed in solvents and/or a polymer compatible to the thermoplastic material.

The thermoplastic materials described above may be prepared by melt compounding the components with equipment known in the art. The equipment may include continuous and batch mixers, for example, Farrel Continuous Mixers available from Farrel Corporation, Ansonia, Conn., Banbury® mixers available from Farrel Corporation, single screw extruders, multiple screw extruders, and the like. In addition, compounding and melt mixing of the components in a continuous fashion may be used.

Collection funnel 12 may be formed by any known molding process. Suitable molding processes may include, but not limited to, injection molding, thermoforming, plug assisted thermoforming, and the like. Flexible strap 14 may be formed by the molding processes listed above, or extruding processes that optionally utilizing calender rolls. In addition flexible strap 14 may be formed from a woven web of thermoplastic fibers.

Frozen dessert machine 80 may be cleaned by draining the frozen desert liquid from machine 80. Water is then used to wash the bulk of the excess mix from machine 80. Water is continuously run through frozen dessert machine 80 and collected in collection funnel 12 that is attached to frozen dessert machine 80 by flexible strap 14. The water flows through fluid outlet 42 in bottom panel 32, flows through hose 86 coupled to fluid outlet 42, and is directed to a drain of sink by hose 86. Once frozen dessert machine 80 is clear, machine 80 is disassembled and all the parts that come in contact with edible food that is consumed by customers is cleaned and sanitized. Frozen dessert machine 80 is then sanitized after the components of the frozen dessert machine have been reassembled. A sanitizing fluid is introduced into the frozen dessert machine 80 while in a clean cycle to completely sanitize the components of frozen dessert machine 80. The sanitizing fluid is then removed from frozen dessert machine 80 through dispensing nozzles 84 thereby also sanitizing dispensing nozzles 84. The sanitizing fluid is collected in collection funnel 12 that is attached to frozen dessert machine 80 by flexible strap 14. The sanitizing fluid flows through fluid outlet 42 in bottom panel 32, flows through hose 86 coupled to fluid outlet 42, and is directed to a drain of sink by hose 86. These steps are repeated until all the cleaning/sanitizing fluid is removed from the frozen dessert machine.

Collection funnel apparatus 10 described above facilitates cleaning a frozen dessert machine 60 in less time than known cleaning techniques. In addition, collection funnel apparatus 10 eliminates the need for a worker from holding a bucket at a frozen dessert machine 60 to collect spent cleaning fluid and then having to carry the heavy filled bucket to a sink to empty the bucket. By eliminating carrying heavy buckets of spent cleaning fluid, the spilling of spent cleaning fluid which may cause a worker to slip and/or fall may be prevented, and also reduces worker fatigue.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A collection funnel apparatus for collecting spent cleaning fluid from a frozen dessert machine, said collection funnel apparatus comprising a collection funnel and a flexible strap attached to said collection funnel, said collection funnel comprising:
a first side member;
an opposing second side member;
a first end member;
an opposing second end member; and
a bottom member having an arcuate shape extending from said first end member to said second end member, said bottom member comprising a fluid outlet;
said first and second side members, said first and second end members, and said bottom member defining a collection cavity.

2. A collection funnel apparatus in accordance with claim 1 wherein said first end member comprising a first strap connecting member extending outward from an outer surface of said first end member, and said second end member comprising a second strap connecting member extending outward from an outer surface of said second end member, said first connecting member comprising a channel extending through said first connecting member, and said second connecting member comprising a channel extending through said second connecting member.

3. A collection funnel apparatus in accordance with claim 1 wherein said flexible strap comprises a first end and a second end, said first end comprises a first hook and loop fastener, and said second end comprises a second hook and loop fastener.

4. A collection funnel apparatus in accordance with claim 3 wherein said flexible strap first end comprises:
a first portion, a second portion and a third portion with said second portion positioned between said first portion and said third portion, a plurality of hooks are attached to said first portion, and a plurality of loops are attached to said third portion of said first end; and
said flexible strap second end comprises:
a first portion, a second portion and a third portion with said second portion positioned between said first portion and said third portion, a plurality of hooks are attached to said first portion, and a plurality of loops are attached to said third portion of said second end.

5. A collection funnel apparatus in accordance with claim 1 wherein said flexible strap further comprises a buckle attached to a center portion of said flexible strap.

6. A collection funnel apparatus in accordance with claim 1 wherein said collection funnel and said flexible strap are formed from a thermoplastic material.

7. A collection funnel apparatus in accordance with claim 6 wherein said thermoplastic material comprises at least one of polyethylene, polypropylene, polystyrene, acrylonitrylstyrene, butadiene, polyethyleneterephthalate, polybutyleneterephthalate, polyarylene ethers, polycarbonates, polyestercarbonates, thermoplastic polyesters, polyetherimides, acrylonitrile-butylacrylate-styrene polymers, nylon, polyarylene ether ketone, polyphenylene sulfide, polyaryl sulfone, polyether sulfone, and polyvinylchloride.

8. A collection funnel apparatus in accordance with claim 7 wherein said flexible strap further comprises at least one elastomer material.

9. A collection funnel apparatus in accordance with claim 8 wherein said elastomer material comprises polyethylene co-polymers formed with at least one of propylene, butene, hexene, octene, ethylidene norbornene, and other alpha-olefin co-monomers, or with polypropylene co-polymers formed with at least one of ethylene, butene, hexene, octene, ethylidene norbornene, and other alpha-olefin co-monomers.

10. A method of removing spent cleaning fluid from a frozen dessert machine, said method comprises:
positioning a collection funnel apparatus on the frozen dessert machine, the collection funnel apparatus comprising a collection funnel and a flexible strap attached to the collection funnel, the collection funnel positioned below at least one nozzle of the frozen dessert machine;
coupling a first end of a hose to a fluid outlet of the collection funnel;
positioning a second end of the hose in a drain or a sink; and
opening at least one nozzle of the frozen dessert machine to permit the spent cleaning fluid to flow into the collection funnel and out the fluid outlet to the drain of sink.

11. A method in accordance with claim 10 wherein the collection funnel comprises:
a first side member;
an opposing second side member;
a first end member;
an opposing second end member; and
a bottom member having an arcuate shape extending from said first end member to said second end member, the fluid outlet positioned in the bottom member;
the first and second side members, the first and second end members, and the bottom member defining a collection cavity.

12. A method in accordance with claim 11 wherein the first end member comprising a first strap connecting member extending outward from an outer surface of said first end member, and the second end member comprising a second strap connecting member extending outward from an outer surface of the second end member, the first connecting member comprising a channel extending through the first connecting member, and the second connecting member comprising a channel extending through the second connecting member.

13. A method in accordance with claim 11 wherein the flexible strap comprises a first end and a second end, the first end comprises a first hook and loop fastener, and the second end comprises a second hook and loop fastener.

14. A method in accordance with claim 13 wherein the flexible strap first end comprises:
a first portion, a second portion and a third portion with the second portion positioned between the first portion and the third portion, a plurality of hooks are attached to the first portion, and a plurality of loops are attached to the third portion of the first end; and
the flexible strap second end comprises:
a first portion, a second portion and a third portion with the second portion positioned between the first portion and the third portion, a plurality of hooks are attached to the first portion, and a plurality of loops are attached to the third portion of the second end.

15. A method in accordance with claim 10 wherein the flexible strap comprises a buckle attached to a center portion of the flexible strap.

16. A method in accordance with claim 14 wherein positioning a collection funnel apparatus on the frozen dessert machine comprises:
inserting the first end of the flexible strap through the channel of the first connecting member, the first portion of the first end is folded around the first connecting member and connecting the first portion to the third portion of the first end by engaging the hooks on the first portion with the loops of the third portion;
inserting the second end of the flexible strap through the channel of the second connecting member, the first portion of the second end is folded around the second connecting member and connecting the first portion to the third portion of the second end by engaging the hooks on the first portion with the loops of the third portion.

17. A method in accordance with claim 16 wherein the flexible strap further comprises a buckle attached to a center portion of the flexible strap, and positioning a collection funnel apparatus on the frozen dessert machine further comprises adjusting the length of the flexible strap with the buckle.

18. A method in accordance with claim 10 wherein the collection funnel and the flexible strap are formed from a thermoplastic material.

19. A method in accordance with claim 18 wherein the thermoplastic material comprises at least one of polyethylene, polypropylene, polystyrene, acrylonitrylstyrene, butadiene, polyethyleneterephthalate, polybutyleneterephthalate, polyarylene ethers, polycarbonates, polyestercarbonates, thermoplastic polyesters, polyetherimides, acrylonitrile-butylacrylate-styrene polymers, nylon, polyarylene ether ketone, polyphenylene sulfide, polyaryl sulfone, polyether sulfone, and polyvinylchloride.

20. A method in accordance with claim 18 wherein the flexible strap further comprises at least one elastomer material.

20. A method in accordance with claim 19 wherein the elastomer material comprises polyethylene co-polymers formed with at least one of propylene, butene, hexene, octene, ethylidene norbornene, and other alpha-olefin co-monomers, or with polypropylene co-polymers formed with at least one of ethylene, butene, hexene, octene, ethylidene norbornene, and other alpha-olefin co-monomers.
